(19) United States
(12) Patent Application Publication
(10) Pub. No.: US 2013/0113929 A1
(43) Pub. Date: May 9, 2013

(54) Systems and methods for surgical procedure safety

(71) Applicant: Mary Maitland DeLAND, Lafayette, LA (US)

(72) Inventor: Mary Maitland DeLAND, Lafayette, LA (US)

(21) Appl. No.: 13/291,581

(22) Filed: Nov. 8, 2011

(51) Int. Cl. H04N 7/18; G06K 9/00

(52) U.S. Cl. 348/143; 382/103; 348/E07.085

(57) ABSTRACT

The systems and methods describe herein can track instruments or tools with one or more cameras adapted to view predetermined areas. A memory unit stores video from the one or more cameras. A recognition unit is adapted to recognize identities and positions of instruments or tools in images produced by the one or more cameras. A control unit is adapted to track positions of the instruments or tools, based on an output of the recognition unit and to store the identities and the positions of the instruments or tools in the memory unit. An output unit is adapted to indicate to an operator, the positions of the instruments or tools in the predetermined areas, and to indicate when all of a predetermined set of instruments or tools in the predetermined areas are located within a view of one or more predetermined cameras of the one or more cameras.

### TECHNICAL FIELD

The invention relates generally to surgical procedures. More particularly, the invention relates to improving the effectiveness and safety of surgical procedures.

### BACKGROUND

A retained surgical instrument is an item unintentionally left in the body of a patient during the course of surgery. Retained surgical instrument probably occur more frequently than “wrong site” surgery, in which surgery is performed on the wrong parts of the body. The consequences of retained surgical instruments include injury (possibly even death), additional surgery to remove the retained surgical instrument and repair any damage caused by the retained surgical instrument, additional hospital costs, and loss of hospital credibility.

It is difficult to measure the instances of retained surgical instruments. According to the U.S. Department of Health and Human Services, the rate may be as high as 1 in 100 surgeries. The rate of retained surgical instruments may be difficult to measure or calculate because retained surgical instruments that do not cause major issues for the patient are not required to be reported. Moreover, staff in hospitals have been discouraged from reporting retained surgical instruments because of liability issues.

Procedures have been developed to minimize retained surgical instruments. These procedures involve the careful counting of all instruments brought to the surgery and careful counting of all instruments remaining at the end of the surgery. These complicated procedures require tracking additional counts if more than one cavity is opened and sub-counts if a cavity is opened within a cavity. The counts are typically recorded on a whiteboard in the operating room. Although, the counts reduce retained surgical instruments, but other factors such as additional errors by staff during the operation, wishful thinking, and dishonesty, may allow instances of retained surgical instruments still occur. Further, during some procedures, instruments can become disassembled, broken, or ripped or cut in to pieces, adding to the problems of counting instruments.

Surgical sponges and swaps are a particular concern as a retained surgical instrument, because these items cannot easily be detected using X-ray, MRI, or CAT scans. For this reason, sponges and swaps sometimes include radiopaque marking, in which before operation, sponges are soaked through with an X-ray-opaque marker. Alternatively, an X-ray detectable marker is placed throughout the width of swaps and sponges used for all invasive procedures. This allows a swap or sponge to be easily seen on plain X-rays. Although radiopaque marking is helpful for correcting a retained surgical instrument after the mistake has been made, radiopaque marking does not prevent the error from occurring.

The consequences of a retained surgical instrument, swap, or sponge range between harmless and fatal. Retained surgical instruments can puncture vital organs and blood vessels, causing internal bleeding. Sponges can fester inside a body, growing increasingly dangerous over time. Additional operations may be necessary, wasting resources that could have been used for other patients.

The current methods to prevent retained surgical instruments include careful counting of the surgical instruments before and after the surgical procedure. Human factors such as exhaustion, lack of tools necessary to aid in producing an accurate count, and a chaotic environment all have been seen to increase the risk of having a retained surgical instrument.

Inaccurate counts are currently the main reason why instruments can be left behind. Many cases of a retained instrument reported a correct sponge count when the patient was released. An inaccurate count can occur when people are deprived of sleep, when the operation is difficult, long, an emergency, or when there are unforeseen changes in the procedure.

In order to improve the system and reduce the number of accidents, some hospitals require four counts of sponges and instruments. The first count happens when the surgical instruments are being set up and the sponges unwrapped. The next count is required right before surgery begins, another count as closure begins, and a count during skin closure.

While careful counting prevents many retained surgical instruments, counting has some drawbacks. Sometimes the patient must be worked on immediately, leaving no time to count the surgical instruments to be used before the surgical procedure begins. After the surgical procedure ends the patient must be left under anesthesia until the count is complete. In addition, the counting is also subject to human error and the majority of retained tools happen even though a correct account of surgical instruments was completed.

### SUMMARY

Exemplary embodiments described herein attempt to overcome the above discussed drawbacks of conventional systems. In particular, the exemplary embodiments attempt to overcome the difficulty of maintaining an accurate count of surgical instruments in the less than ideal situation of an operating room and reduce the additional burden of instrument counting on the medical staff and the patient undergoing surgery. In embodiments, [symbol] .

In one embodiment, a system for tracking instruments or tools with one or more cameras adapted to view predetermined areas. A memory unit that stores video from the one or more cameras. A recognition unit adapted to recognize identities and positions of instruments or tools in images produced by the one or more cameras. A control unit adapted to track positions of the instruments or tools, based on an output of the recognition unit and to store the identities and the positions of the instruments or tools in the memory unit. An output unit adapted to indicate to an operator, the positions of the instruments or tools in the predetermined areas, and to indicate when all of a predetermined set of instruments or tools in the predetermined areas are located within a view of one or more predetermined cameras of the one or more cameras.

In another embodiment, a method of tracking surgical instruments comprising 1) imaging predetermined areas with one or more cameras to form time sequences of images, 2) storing the time sequences of the images in a memory, 3) recognizing, by a recognition unit, an identity and positions of the instruments or tools in the images of the predetermined areas, 4) tracking movement of the instruments or tools in and between the predetermined areas using the recognized instruments or tools and the positions of the recognized instruments or tools, 5) storing a time of the movement of each instrument or tool and storing the identity of the instrument or tool and the time in the memory, and 6) indicating when a predetermined set of instruments or tools is in predetermined ones of the predetermined areas.

### BRIEF DESCRIPTION OF THE DRAWINGS

The accompanying drawings constitute a part of this specification and illustrate an embodiment of the invention and together with the specification, explain the invention.

FIG. 1 illustrates a simplified layout of an operating room.

FIG. 2 illustrates a simplified layout of and operating room, according to an embodiment.

FIG. 3 illustrates the components of an instrument tracker, according to an embodiment.

FIG. 4 illustrates a method of initiating the surgical instrument tracker according to an embodiment.

FIG. 5 illustrates an example of measuring the size for one surgical instrument, according to an embodiment.

FIG. 6 illustrates a method for tracking instruments, according to an embodiment;

FIG. 7 illustrates a method for reviewing the movement of instruments between the surgery tray, the operating table in the back tray, according to an embodiment; and

FIG. 8 illustrates an exemplary display of the video on a display, according to an embodiment.

### DETAILED DESCRIPTION

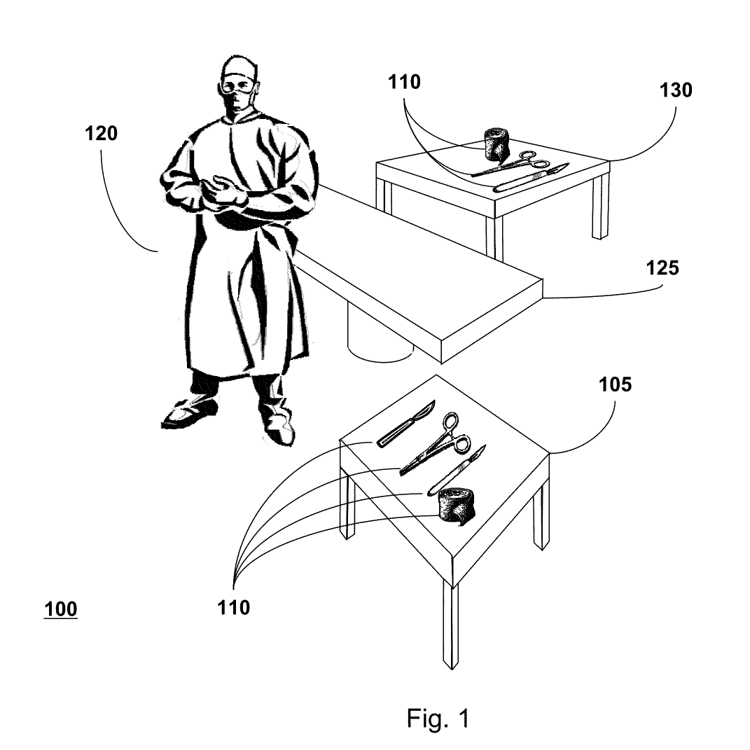

FIG. 1 illustrates a simplified layout of an operating room 100. Before a surgical procedure, a surgical tray 105 with instruments 110 required for the surgical procedure is assembled. The surgical instruments 110 on the surgical tray 105 are initially documented and counted. Once the surgical procedure begins instruments are handed to the surgeon 125 for use at the operating table 115. When the surgeon is finished with a particular instrument 110, the surgical instrument 110 may be placed on a back tray if contaminated or not required again in the surgical procedure. Alternatively, the surgical instruments 110 are placed back on the surgical tray 105. The surgeon 125 may ask for additional instruments or sutures that a technician will additionally supply. All additional instruments need to be accounted for. At the end of the procedure, the surgical instruments 110 remaining on surgical tray 105 and back tray 130 are counted, and compared with the initial count of instruments 110 and the additional instruments 110 added during the procedure. In a typical surgery, 250-300 surgical tools may be used. The number significantly increases when a more complex surgery is performed. Thus, keeping track of all of the surgical instruments 110 can be extremely burdensome. Furthermore, the patient cannot leave the operating room 100 until the count is complete, and some institutions require the count to be repeated a number of times before the patient can leave the operating room 100.

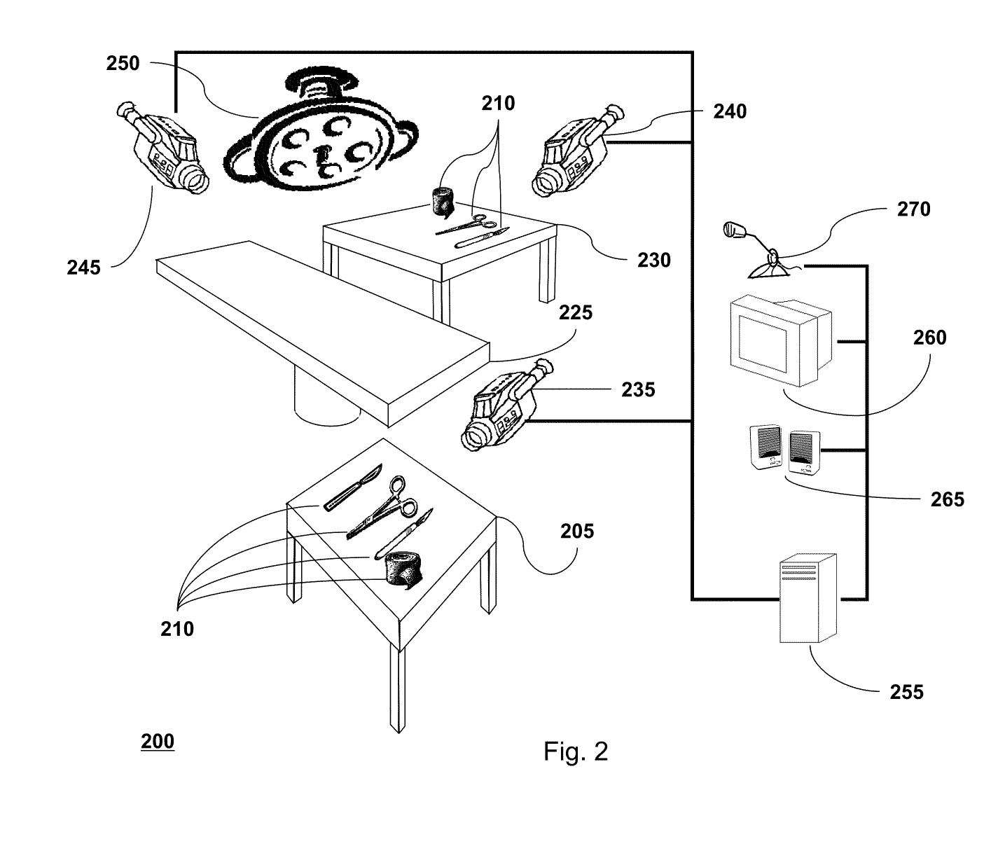

FIG. 2 illustrates a simplified layout of and operating room 200, according to an embodiment. The operating room 200 comprises a surgical tray 205 with instruments 210. Surgical tray 205 has a surgical tray camera 235 positioned so that all of the surgical instruments 210 placed on the surgical tray 205 are within view of the surgical tray camera 235. Before the surgical procedure the surgical instruments required for the surgical procedure are assembled on surgical tray 205. During the surgical procedure, surgical instruments 210 are handed from the tray 205 to the surgeon, for example, surgeon 120 (FIG. 1) to perform the surgical procedure on a patient on surgical table 225. When the surgeon has finished with each surgical instrument 210. the surgical instrument 210 is either placed back on surgical tray 205 for further use, or placed on back tray 230 if the surgical instrument is not required again during the surgical procedure. The back tray 230 has a back tray camera 240 positioned so that all the surgical instruments 210 placed on the back tray 230 are within view of the back tray camera 240. A surgery table camera 245 is positioned over the surgery table 225 to record the surgery. In some embodiments, the surgery table camera 245 is a part of the surgery lamp structure 250. In some embodiments, the surgery table camera 245 is separate from the surgery lamp structure 250.

The cameras 235, 240 and 245 may each comprise multiple cameras positioned to jointly view the surgical tray 205, the back tray 230, and the surgery table 225. Thus, for example, the surgical tray camera 235 may comprise four cameras, each of which views a separate quarter of the surgical tray 205 in greater detail. The four cameras can be used to produce a composite image with four times the detail of a single camera position to image the entire surgical tray 205. Alternatively, the surgical tray camera 235 may comprise four cameras that are positioned to view the surgical tray 205 from different angles. Based on the different views from the four cameras of the surgical tray 205, a 3D representation of the surgical tray 205 and the surgical instruments on the surgical tray 205 can be constructed. The back camera 240 and the surgery table camera 245 may also comprise more than one camera arranged for more detail or to produce a 3D representation of the back tray 230 and the patient and surgical instruments 210 on the surgery table 225.

Alternatively, the cameras 235, 240 and 245 maybe 3D cameras, high definition cameras, or any other type of camera compatible with embodiments of the disclosure.

The cameras 235, 240 and 245 are connected to a surgical instrument tracker 255. In some embodiments, the connection is a wired connection, in other embodiments the connection is a wireless connection, such as WiFi or Bluetooth™. In some embodiments, the surgical instrument tracker is formed from dedicated hardware. In some embodiments, the surgical instrument tracker 255 is formed from a combination of dedicated hardware and a computer. Instructions for the computer may be recorded on a computer readable medium, for example, a hard disk, a CD-ROM, a DVD, or flash memory. The surgical instrument tracker 255 is connected to a display 260 to display output from the surgical instrument tracker 255 and also connected to speakers 265 to output speech and sounds from the surgical instrument tracker 255. In some embodiments, the surgical instrument tracker 255 is also connected to a microphone 270. The microphone 270 can be used to input voice commands to the surgical instrument tracker 255. In some embodiments, the display 260 includes a touch screen for controlling the surgical instrument tracker 255. In some embodiments, the surgical instrument tracker 255 is connected to one or more of a keyboard a mouse, a track ball or a joystick for controlling the surgical instrument tracker 255. In some embodiments, the microphone 270, the display 260, and the speakers 265 are formed as part of the instrument tracker 255.

In addition to the cameras 235, 240 and 245, in other embodiments, additional cameras can be connected to the instrument tracker 255. The additional cameras may be positioned to view any position of the operating room where surgical instruments can be placed. The additional cameras can be used, as discussed below for the cameras 235, 240, 245 to track surgical instruments in the operating room. The additional cameras can be positioned to view additional areas where surgical instruments may legitimately be placed. Alternatively, the additional cameras maybe positioned to view areas where surgical instruments should not be placed.

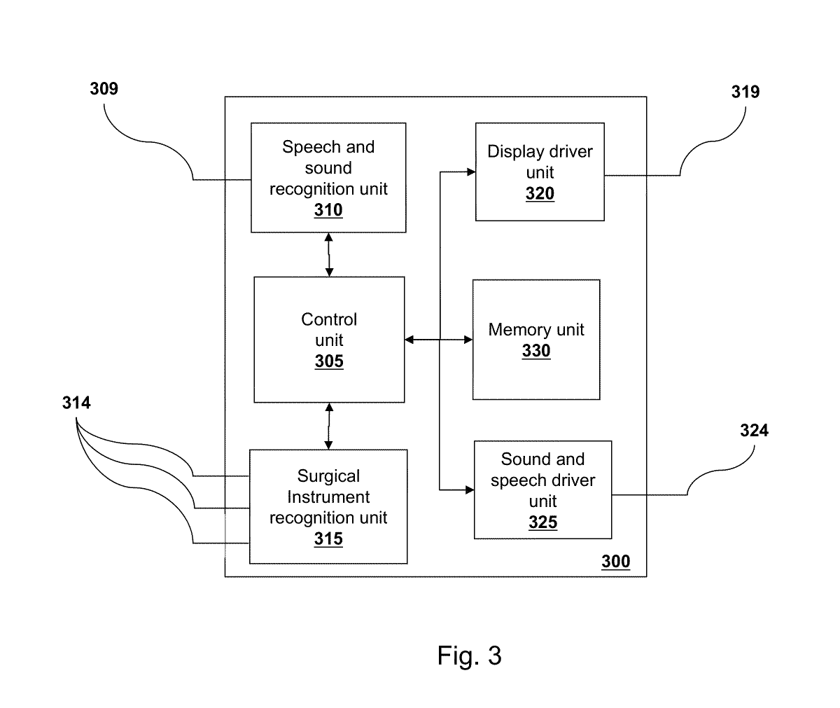

FIG. 3 illustrates the components of an instrument tracker 300. The surgical instrument tracker 300 comprises a control unit 305, which controls a speech and sound recognition unit 310, the surgical instrument recognition unit 315, a display driver 320, a sound and speech driver unit 325 and a memory unit 330.

The control unit 305 is connected to the speech and sound recognition unit 310, the surgical instrument recognition unit 315, the display driver 320, the sound and speech driver 325, and the memory unit 330. In some embodiments, the above units are connected by a dedicated bus. In other embodiments, the above units are embedded in the same piece of hardware.

The speech and sound recognition unit 310 is connected to a microphone input 309, for a microphone, for example, microphone 270. The speech and sound recognition unit 310 processes the input from the sound detected by the microphone and converts the sound into data representing words, phrases and sounds. The data representing the words, phrases and sounds is sent to the control unit 305. Depending on the sound data sent to the control unit 305, the control unit 305 controls the remaining units 320-330 of the surgical instrument tracker 300.

The surgical instrument recognition unit 315 processes, image or video data input at camera inputs 314 from, for example, cameras 235, 240, 245. The images and video data are processed to output the locations and identity of surgical instruments recognized in the image or video data from the cameras. In some embodiments, the surgical instrument recognition unit 315 comprises a memory that stores data and images used to recognize the surgical instruments in the images or video data. In other embodiments, the surgical instrument recognition unit 315 countries. The images and data used to recognize the surgical instruments and the images or video data from the memory unit 330. The identity and locations of the recognize surgical instruments are sent to the control unit 305. Based on the identity and locations of the recognize surgical instruments sent to the control unit 305 the control unit 305 controls the display driver 320, the standard speech driver 325 and the memory unit 330.

The display driver unit 320 controls the display connected to display output 319, for example, display 260, based on data and control information sent to the display driver 320 by the control unit 305. The display driver unit 320 may also control a touch screen that forms a part of any attached display. The display driver unit 320 passes any controls detected via the touch screen of the display to the control unit 305. The control unit 305 controls the display unit 320, the sound and speech driver unit 325 and the memory unit 330 based on the controls from the touch screen of the display.

The sound and speech driver unit 325 generates sounds and synthesized speech, at sound output 324 based on controls received from the control unit 305. This allows the driver unit 325 to output the sounds for speakers, for example, speakers 265.

The memory unit 330 stores the positions and the identities of surgical instruments on the surgery tray the back tray, and the operating table. In some embodiments, the positions and identities of the surgical instruments are stored in a database formed in the memory unit 330. In other embodiments, the positions and identities of the surgical instruments are stored in tables in the memory unit 330. The memory unit 330 may also store instructions for the control unit to perform various functions, states of the surgical instrument tracker 300, user preferences of the user of the surgical instrument tracker 300. The memory unit 330 may also store drivers for the speech and seven recognition unit 310, the surgical instrument recognition unit 315, the display driver unit 320, and the sound and speech driver unit 325.

The control unit 305 uses the information obtained from the speech and sound recognition unit 310, the surgical instrument recognition unit 315, and any input device, such as a touch screen, mouse, or keyboard to monitor the positions of the surgical instruments before and during the surgical procedure. The control unit 305 stores the positions of the surgical instruments, the times that the surgical instruments are moved in the operating room, and video from the cameras in the memory unit 330. The control unit 305 instructs the display driver unit and/or the sound and speech driver unit to inform the medical staff in the operating room when all of the instruments are accounted for, that is, placed on one of the surgical tray or the back tray. The control unit 305 also indicates to the medical staff using the display unit 320 and/or the sound and speech driver unit 325, inconsistencies between the surgical instruments detected in the images from the cameras and information stored in the memory 330 regarding where the surgical instruments are placed. The instrument tracker 300 tracks the surgical instruments during the surgical procedure, as discussed in detail below.

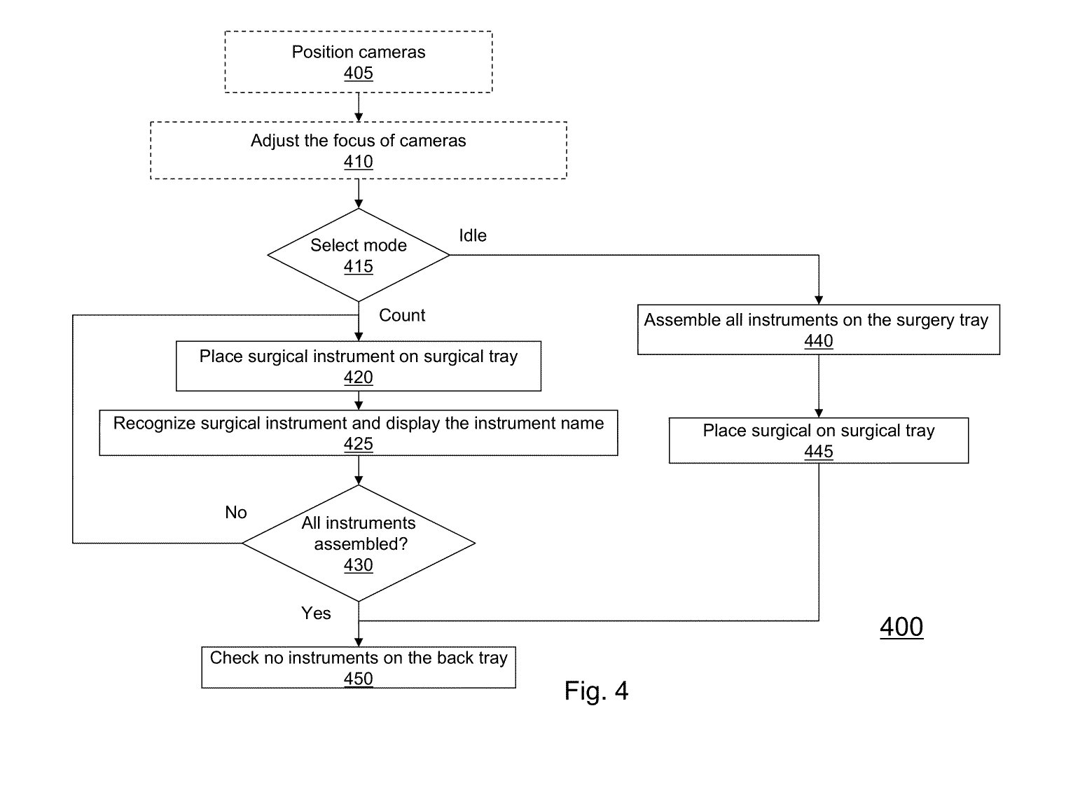

Before a surgical procedure begins, the surgical instrument tracker, for example, surgical instrument tracker 255 is initiated. FIG. 4 illustrates a method 400 of initiating the surgical instrument tracker.

The method begins at step 405. At step 405, the method includes an optional step for positioning of the cameras, for example, cameras 235, 240 and 245 over for example, surgical tray 205, surgery table 225 and the back tray 230 respectively. The positioning of the cameras can be checked by observing an image from each of the cameras on the display, for example, display 260. The cameras are adjusted to see all of the top surface of the surgical tray, the surgery table and the back tray. When the cameras are positioned the method proceeds to step 410. As noted above, additional cameras may also be positioned to view other parts of the operating room where surgical instruments are placed, as well as positioned over parts of the operating room where surgical instruments should not be placed. In some embodiments, during positioning, the member of the medical staff has to position the cameras, input to the instrument tracker the position each camera is viewing, and indicate if this position is a place surgical instruments are allowed to be placed. The member of the medical staff may also be required to indicate to the instrument tracker if each position is a place that instruments can remain at the end of the procedure. In this manner, the cameras are flexible, and can be moved around the operating room as required.

At step 410, the focus of the cameras may optionally be adjusted. In some embodiments, the cameras are auto-focus so that the camera focus does not require adjustment. When the focus of the cameras is adjusted the method proceeds to step 415.

At step 415, a mode for assembling the surgical instruments is selected. If an idle mode is selected during the process of assembling the surgical instruments, the surgical instrument tracker does not track the surgical instruments as the surgical instruments are placed on the surgical tray, and the method proceeds to step 440. If a tracking mode is selected the surgical instrument tracker is placed in a mode in which the image from the camera is used to recognize and count the surgical instruments as the surgical instruments are placed on the surgical tray and the method proceeds to step 420.

At step 420 a surgical instrument is placed on the surgical tray in the method proceeds to step 225. At step 425, the surgical instrument tracker recognizes the surgical instrument placed on the surgical tray. In some embodiments, the surgical instrument tracker displays a list of the surgical instruments currently on the surgical tray. In some embodiments, the surgical instrument tracker displays the identity of the last instrument added to the surgical tray. In some embodiments, the surgical instrument tracker indicates the identity of the last instrument added to the surgical tray using a speech synthesis system in the surgical instrument tracker to say the name of the surgical instrument added to the surgical tray. Thus, for example, if a scalpel is placed on the surgical tray, the surgical instrument tracker may say, “a scalpel has been placed on the surgical tray.” Thus, as the surgical instruments are added to the surgical tray, the member of the medical staff assembling the surgical instruments will know that the surgical instrument tracker, has recognized the surgical instrument correctly. When the surgical instrument tracker has recognized the surgical instrument, the method proceeds to step 430.

At step 430, the member of the medical staff assembling the surgical instruments determines if all of the surgical instruments for the procedure have been added to the surgical tray. If all of the surgical instruments have been added to the surgical tray, the method proceeds to step 450. If not all of the surgical instruments have been added to the surgical tray, the method repeats steps 420-430.

At step 440 if the idle mode is selected, the member of the medical staff assembles the surgical instruments on the surgical tray. When the surgical instruments are all assembled the method proceeds to step 445. At step 445 the member of the medical staff instructs the surgical instrument tracker to identify and count the surgical instruments on the surgical tray. The member of the medical staff may instruct the surgical instrument tracker using voice commands via the microphone or via a one of the input methods discussed above. The surgical instrument tracker, then attempts to identify and count the surgical instruments on the surgical tray. When the instrument tracker has completed detecting all of the surgical instruments on the surgical tray the method proceeds to step 450

At step 450, the surgical instrument tracker performs a similar process to identify surgical instruments on the back tray, for example, back tray 230, to check that there are no surgical instruments on the back tray. If surgical instruments are found o the back tray these instruments have to be removed from the back tray, or an explanation has to be recorded in the surgical instrument tracker as to why these instruments are on the back tray.

When the instrument tracker has completed checking the back tray for surgical instruments the surgical instrument tracker is ready to begin the surgical procedure.

In some embodiments, the instrument tracker stores a set of templates for procedures. The templates include a list of all of the surgical instruments required for a particular procedure. Before beginning to assemble the instruments for the procedure, the member of the medical staff selects the procedure from a list displayed by the surgical instrument tracker. As the surgical instruments are assembled on the surgical tray, the surgical instrument tracker recognizes the surgical instruments and checks off the surgical instruments listed in the template. The member of the medical staff can request the surgical instrument tracker to display a list of surgical instruments already on the surgical tray and/or a list of surgical instruments missing from the surgical tray. When all of the surgical instruments required for the procedure are assembled on the surgical tray, the instrument tracker indicates to the member of the medical staff that all of the required surgical instruments are present on the surgical tray.

The templates for procedures can be edited, created and deleted. In some embodiments, the templates can be associated with a particular member of the medical staff. Thus, the templates can be customized to suit the tastes of a particular surgeon performing a particular procedure.

To identify and count the surgical instruments on the surgical tray, the surgical instrument tracker processes the image from the cameras, using, for example, surgical instrument recognition unit 315. A number of techniques may be used to identify the surgical instruments.

A first method to identify and count the surgical instruments is to match the size and shape on various features in the image from the camera, for example, camera 235, with sizes and shapes of surgical instruments stored in a database in the memory of the surgical instrument tracker, for example, memory unit 330.

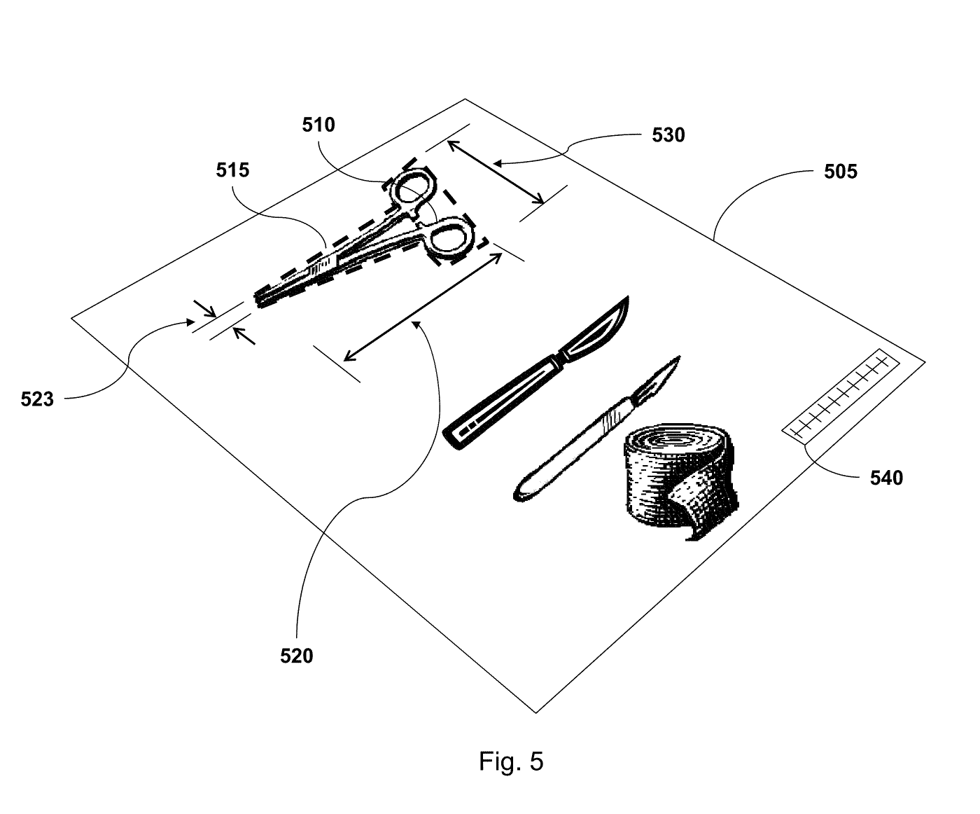

FIG. 5 illustrates an example of measuring the size for one surgical instrument 510. To perform this procedure the surgical instrument tracker, first processes the image to identify areas of the image that belong to each surgical instrument on the surgical tray 505. The areas that belong to each surgical instrument are then analyzed to find one or more dimensions of each of the areas. The dimensions may include, for example, the maximum length in one direction, the minimum length in the same dimension, the maximum and minimum width in a perpendicular direction to the length. For example, surgical instrument 510, has approximate area 515. The approximate area 515 has maximum length in one direction 520. In the direction perpendicular to the length 520 the approximate area 515 has a minimum length 525 and a maximum width 530. The dimensions of surgical instrument 510 are sufficient to distinguish instrument 510 from the remaining instruments on the surgical tray 505. The above widths and lengths may be compared to a known scale 540 also placed on the surgical tray 505, or to the size of the surgical tray 505. Any distortion in the shape of the surgical instrument 510 due to the camera not pointing directly along an axis perpendicular to the surface of the surgical table 505 may be corrected by using a scale 540 to correct the errors caused by the off axis position of the camera.

A second method to identify and count the surgical instruments is to match the color and texture of the surgical instruments with the color and texture of surgical instrument stored in the database of the surgical instrument tracker. For example, an average of the color inside the area 515 of surgical instrument 510 can be calculated. The average of the color may be one or more of the mean color, the mode of the color, or the median of the color. The texture can be evaluated by, for example, performing a Fourier transform of the data representing the area 515, and choosing the spatial frequency corresponding to one or more peaks in the Fourier transform. Thus, for a knurled handle the spatial frequency corresponding to the knurling pattern would appear as a peak in the Fourier transform. Cloth material in swabs and sponges will have peaks corresponding to the fiber patterns on the surface of these items. These peaks may also be compared with peak stored in a database of the surgical instrument tracker.

A third method to identify and count the surgical instruments is to store images of the various surgical instruments in a database on the surgical instrument tracker. The images stored, may be taken to show various views of each surgical instrument. The surgical instrument tracker then passes each stored image over the image of the surgical tray 505, and using autocorrelation techniques identifies the positions in the image of the surgical tray that correspond to the stored image. The stored image may be manipulated before the autocorrelation to correspond with the angle of the surgical tray to the camera. Further, the size of the stored image may be manipulated to correspond with the expected size of the surgical instrument in the image of the surgical tray 505 based on the size of the surgical tray 505 in the image from the camera, or the size of the scale 540 in the image from the camera.

In some embodiments, combinations of the above three techniques, and any additional techniques, can be used to determine and confirm the location and identity of the surgical instruments.

For each surgical instrument detected, the surgical instrument tracker stores the surgical instrument name, and the area in the image that the surgical instrument occupies. Thus, if the image in the area occupied by the surgical instrument is changed, the surgical instrument tracker can detect which surgical instrument has been moved from the surgical tray.

If the surgical instrument tracker cannot identify a surgical instrument on the surgical tray, or the back tray at any time, the surgical instrument tracker indicates to the member of the medical staff that one or more surgical instruments cannot be identified. The surgical instrument tracker may indicate that one or more of the surgical instruments cannot be identified using the display, for example, display 260 or by using the speakers, for example, speakers 265. In some embodiments, the surgical instrument tracker may use synthesized speech to indicate that one or more instruments cannot be identified. A member of the medical staff may then instruct the surgical instrument tracker to indicate which surgical instrument cannot be identified. The surgical instrument tracker then displays an image of the surgical tray or the back tray on the display, highlighting the area on the surgical tray occupied by the unidentifiable surgical instrument. The surgical instrument that is unidentifiable can then be moved by the member of the medical staff, so that the surgical instrument tracker can attempt to identify the surgical instrument a second time. When the member of the medical staff has moved the unidentifiable surgical instrument, the member of the medical staff instructs the surgical instrument tracker that the unidentifiable surgical instrument is repositioned and the surgical instrument tracker attempts to identify the surgical instrument. If the above process for identifying the surgical instrument fails, the member of the medical staff may identify the surgical instrument for the surgical instrument tracker. The identification may be performed by selecting from a menu or series of menus the surgical instrument that the unidentifiable surgical instrument corresponds to, or alternatively, by typing the name of the unidentifiable surgical instrument into the surgical instrument tracker.

In some embodiments, if the surgical instrument tracker cannot identify a surgical instrument, and the surgical instrument cannot be found on menus within the surgical instrument tracker, the surgical instrument may be added to the database within the surgical instrument tracker. To add the surgical instrument to the database of the surgical instrument tracker, the unidentifiable instrument is placed on the surgical tray away from other instruments. The member of the medical staff then uses a touch screen on the display of the surgical instrument tracker or another one of input devices discussed above to indicate the location of the unidentifiable surgical instrument. In some embodiments, the surgical instrument tracker may request the member of the medical staff to reposition the surgical instrument several times to record images of the surgical instrument from different angles. Using the one or more images obtained, the surgical instrument tracker updates the database of surgical instruments stored in, for example, memory unit 330, with the newly identified surgical instrument. The above process allows the surgical instrument tracker to deal with unusual surgical instruments, unique surgical instruments developed for very specific procedures and experimental surgical instruments.

When the surgical procedure is ready to begin an instruction is given to the surgical instrument tracker either via the microphone, the touch screen, or another input device to begin tracking instruments. As each surgical instrument is removed from the surgical tray, for example, surgical tray 205 to be used by the surgeon, the surgical instrument tracker records, which surgical instrument was removed, and the time the surgical instrument was removed. The surgical instrument, and the time the surgical instrument was removed are recorded in a surgical instrument tracking database. In some embodiments, the surgical instrument tracker uses a synthesized or recorded voice to indicate which surgical instrument the surgical instrument tracker believes has been removed from the surgical tray. Thus, for example, the surgical instrument tracker might say, “a scalpel has been removed from the surgical tray.” In some embodiments, the surgical instrument tracker also records video from all the cameras in the operating room, along with the time of each frame in the videos. Moreover, each time a surgical instrument is placed back on the surgical tray, or the back tray, for example, back tray 230, the surgical instrument tracker identifies the surgical instrument and records the time that the surgical instrument was placed on the surgical tray or the back tray. The surgical instrument tracker also records which of the surgical tray or the back tray that the surgical instrument was placed on. In some embodiments, when the surgical instrument tracker believes that a surgical instrument has been placed on either the surgical tray or the back tray, the surgical instrument tracker may indicate using a synthesized or recorded voice which surgical instrument has been placed and on which tray.

In some embodiments, the surgical instrument tracker requires a member of the medical staff to confirm the identity of the surgical instrument each time a surgical instrument is removed from or replaced on one of the surgical tray and the back tray. The confirmation may be input to the surgical instrument tracker via a touch screen on the display, via some other input device, such as a mouse or keyboard, or via speech recognition and the microphone.

In some embodiments, the surgical instrument tracker is capable of recognizing that a surgical instrument has been placed on top of another surgical instrument. The surgical instrument tracker does this by noting that a change has occurred in the image of the surgery tray or the back tray where a surgical instrument is already known to exist. If the new image in that area corresponds to a different instrument or alternatively, does not correspond to any instrument, the surgical instrument tracker can determine that the newly placed instrument has been positioned over an existing instrument. In some embodiments, the instrument tracker requires a member of the medical staff to separate the two instruments on the surgical tray or the back tray. In other embodiments, the surgical instrument tracker stores the two instruments as having an identical location, if the surgical instrument tracker is capable of identifying the two instruments. If the instrument tracker cannot identify both of the surgical instruments, the surgical instrument tracker requires a member of the medical staff to identify the two instruments, and records the two instruments as having the an identical location. In some embodiments, the instrument tracker is able to deal with three or more instruments placed in the same location on the surgery tray or the back tray using a similar technique to the technique described above.

If the medical staff in the operating room believe that the instrument tracker has misidentified a surgical instrument or the location where the surgical instrument has been placed, the surgical instrument tracker allows the medical staff in the operating room to correct the surgical instrument tracker. The surgical instrument tracker records the correction, and checks that the correction is consistent with the surgical instrument tracker's current understanding of the positions of the surgical instruments. Thus, for example, if a scalpel is placed on the back tray, and no scalpel was ever removed from the surgical tray, the instrument tracker questions where the scalpel came from. The surgical instrument tracker gives the medical staff in the operating room the opportunity to explain the inconsistency, and records the explanation.

If the surgical instrument tracker cannot recognize a surgical instrument placed back on the surgical tray or the back tray, the surgical instrument tracker indicates that the surgical instrument could not be recognized. The instrument tracker allows the medical staff in the operating room to identify the surgical instrument and checks that the identity is consistent with the surgical instrument tracker's understanding of the current positions of the surgical instruments. If the identity is not consistent with the current positions of the surgical instruments, the instrument tracker gives the medical staff in the operating room the opportunity to explain the inconsistency and records the explanation.

At any point during the procedure, when all of the surgical instruments are either on one of the surgical tray or the back tray, the surgical instrument tracker notifies the medical staff in the operating room that all of the surgical instruments are accounted for. In some embodiments, the surgical instrument tracker informs the medical staff using a sound generated on the speakers. In some embodiments, the surgical instrument tracker generates synthesized speech using the speakers. The surgical instrument tracker might say, for example, “All instruments are currently accounted for.” In other embodiments, the surgical instrument tracker may display a message on the screen to indicate that all the surgical instruments are accounted for.

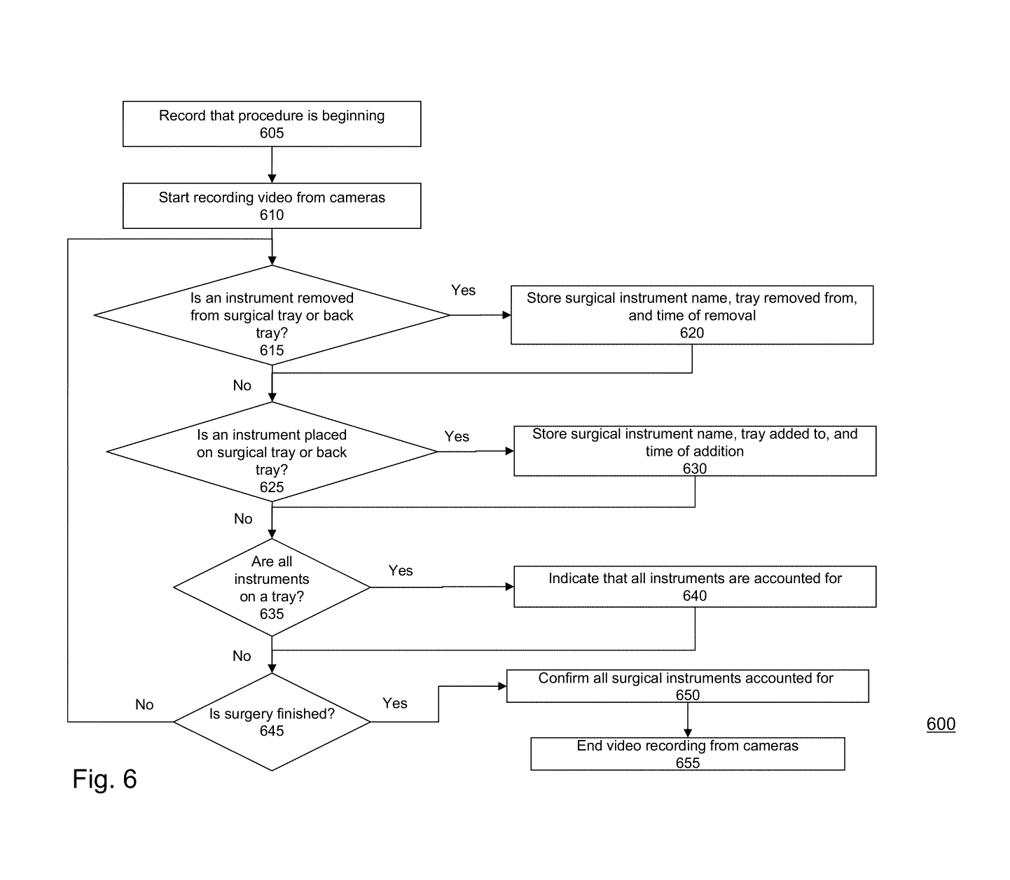

FIG. 6 illustrates a method 600 for tracking instruments. The method begins at step 605. At step 605, the surgical instrument tracker records that a member of the medical staff indicated to the surgical instrument tracker that the surgical procedure has begun. The method proceeds to step 610. At step 610, the surgical instrument tracker starts recording video and images from all of the cameras in the operating room. The time and date of each image or frame of the video is stored with that image or frame in a database or a flat file in the memory of the surgical instrument tracker. When the video has been started, the method proceeds to step 615.

At step 615, the surgical instrument tracker checks to see if any surgical instrument has been removed from the surgical tray or back tray. If a surgical instrument has been removed from the surgical tray or the back tray, the method proceeds to step 620. If no surgical instrument has been removed, the method proceeds to step 625. At step 620, the surgical instrument tracker stores the surgical instrument name, the tray the instrument was removed from and the date and time of removal. The surgical instrument tracker stores the above information in a database or flat files in the memory of the surgical instrument tracker. The surgical instrument tracker may also store the positions of each instrument during the surgical procedure. Thus, for example, the surgical instrument tracker may store a first list of all the instruments on the surgical tray, a second list of all the instruments on the back tray, and a third list of all instruments at the operating table. When a surgical instrument is removed from one of the surgical tray or the back tray, the above lists may be updated. The above lists may also contain information regarding the position in image of each of the instruments. Using the above lists, the surgical instrument tracker can rapidly answer a query regarding where any particular instrument is currently positioned, and indicate on an image of one of the surgical tray, the operating table or the back tray where the instrument is positioned. When the instrument tracker has finished storing and updating all of the surgical instrument position data, the method proceeds to step 625.

At step 625, the surgical instrument tracker checks to see if any surgical instrument has been added to the surgical tray or back tray. If a surgical instrument has been added to the surgical tray or the back tray, the method proceeds to step 630. If no surgical instrument has been added, the method proceeds to step 635. At step 630, the surgical instrument tracker stores the surgical instrument name, the tray the instrument was added to and the date and time of addition. The surgical instrument tracker stores the above information in the database or flat files in the memory of the surgical instrument tracker. The surgical instrument tracker may also update the lists indicating which instruments are on the surgical tray, the back tray and the operating table. When the instrument tracker has finished storing and updating all of the surgical instrument position data, the method proceeds to step 635.

At step 635, the surgical instrument tracker checks to see if all of the instruments are present on at least one of the surgical tray or the back tray. If all of the instruments are present on one of the surgical tray or the back tray, the surgical instrument tracker assumes that no surgical instruments remain on the operating table. If all of the surgical instruments are present on one of the surgical tray or the back tray, the method proceeds to step 640, if not, the method proceeds to step 645.

At step 640, the surgical instrument tracker indicates to the members of the medical staff that all of the surgical instruments are accounted for. In some embodiments, the above information is displayed on the screen of the surgical instrument tracker. In other embodiments, the surgical instrument tracker generates a sound on the speakers or generates an indication using a synthesized or recorded voice. The method proceeds to step 645.

At step 645, the surgical instrument tracker checks to see if the medical staff have indicated that the surgery is finished. If the surgical instrument tracker detects that the surgery is finished, the method proceeds to step 650. At step 650, the surgical instrument tracker confirms that all surgical instruments are accounted for. The confirmation procedure may include a member of the medical staff identifying each of the surgical instruments with the surgical instrument tracker. The member of the medical staff confirms the identities by inputting information to the surgical instrument tracker indicating that each instrument on the surgical tray and the back tray corresponds to the surgical instrument that the surgical instrument tracker believes to be present at each position on the surgical tray and the back tray. When the confirmation is complete the method proceeds to step 655. At step 655, the video recording from the cameras over the surgical tray, the back tray and the operating table is stopped and the method terminates.

If at any point during the procedure, the surgical instrument tracker indicates that all of the surgical instruments are accounted for and the medical staff in the operating room disagree, believing that not all of the surgical instruments are on one of the surgical tray and the back tray, the surgical instrument tracker can be instructed to correct the error by, for example, the staff placing the additional surgical instrument on to one of the trays and identifying the surgical instrument for the surgical instrument tracker. The surgical instrument tracker can also be queried regarding where on the surgery tray and the back tray the surgical instrument tracker has recorded the positions of instruments that are not on one of the surgery table or the back tray. For example, if the surgical instrument tracker indicates that all of the surgical instruments are accounted for and the surgeon is holding a scalpel, the surgical instrument tracker can be queried as to the positions of scalpels on the surgery tray and the back tray. Further, the instrument tracker can be queried as to the position of the last scalpel placed on one surgery table or the back tray, or the position of the last scalpel moved from one of the surgery table or the back tray. The surgical instrument tracker indicates the positions of the above instruments by, for example, highlighting the position on the image of the surgery table or the back tray. The medical staff in the operating room can then check the identity of the highlighted item and if necessary update the information in the surgical instrument tracker.

Moreover, the surgical instrument tracker can be requested to play back video corresponding to the time the video tracker recorded each surgical instrument being moved. The video for both the surgical tray, the back tray and the surgery table can be played, so that at the time the surgical instrument was moved, the surgical instrument can be seen moving from, for example, the surgical tray to the operating table. The surgical instrument can then be seen in the video being used on the patient, and then being returned to the surgical tray or the back tray.

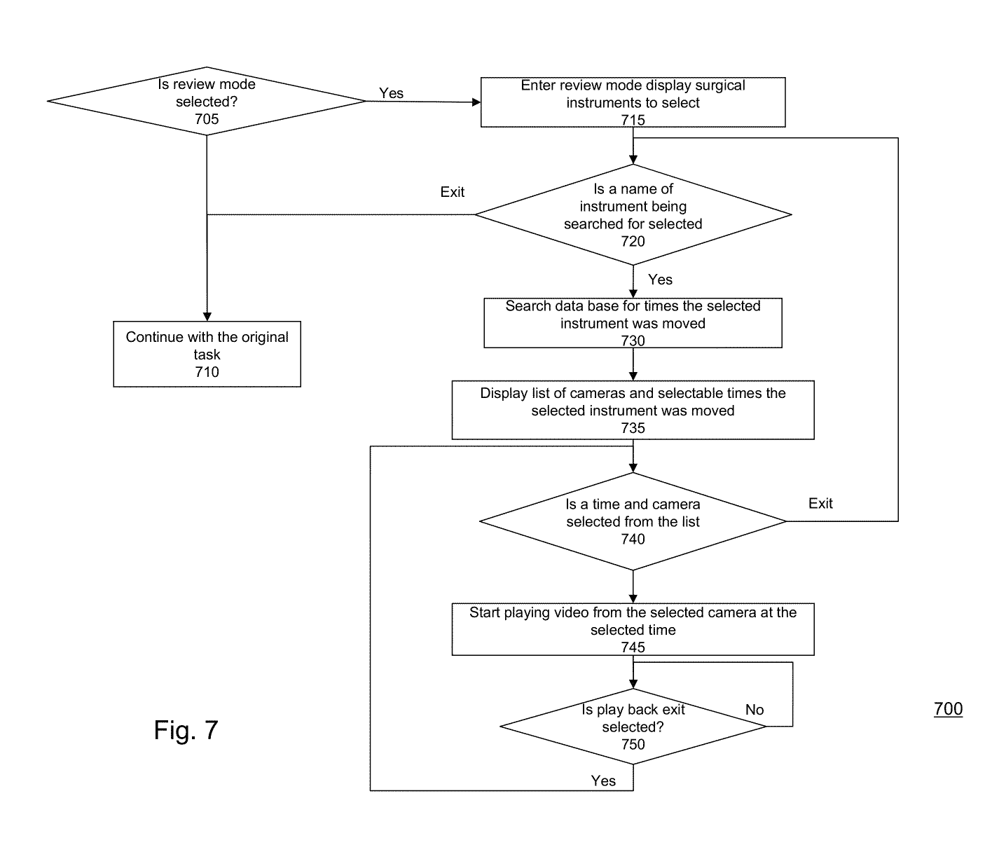

FIG. 7 illustrates a method 700 for reviewing the movement of instruments between the surgery tray, the operating table and the back tray. The method begins at step 705. At step 705, the surgical instrument tracker determines if the review mode is selected. If the review mode is not selected the surgical instrument tracker proceeds to step 710, where the instrument tracker continues to perform the task it is currently assigned to. If the review mode is selected, the method proceeds to step 715.

At step 715, the surgical instrument tracker enters the review mode and displays a list of surgical instruments to select. In some embodiments, if the surgical instrument tracker is already aware that the particular surgical instrument or instruments is misplaced, the instrument tracker may only list the misplaced surgical instrument or instruments. In some embodiments, the instrument tracker only the displays a list of surgical instruments that have been moved since the surgical procedure began. When a list of surgical instruments to select is complete the method proceeds to step 720. At step 720 the surgical instrument tracker checks to see if a surgical instrument has been selected. The exit is selected, rather than a surgical instrument, the method proceeds to step 710 and continues with the original task. If the name of an instrument is selected, the surgical instrument tracker proceeds to step 730.

At step 730, the surgical instrument tracker searches the database for times that the selected instrument was moved from one of the surgery tray, the back tray and the operating table. When the surgical instrument tracker has found all of times that the instrument was moved, the method proceeds to step 735. At step 735, the instrument tracker displays a list of the times that the selected surgical instrument was moved along with buttons or other menu items to select playing the video from one or more of the cameras. In some embodiments, if the instrument was moved from the surgical tray to the operating table at a particular time, but has never be moved to the back tray, the surgical is my tracker may only display buttons for the surgical tray camera and the operating table camera. In other embodiments, buttons for all of the cameras are displayed. When the display is completely updated, the method proceeds to step 740. At step 740, the surgical instrument tracker checks to see if a camera is selected from the list. If exit is selected from the list, the method proceeds to step 720, to allow for a different surgical instrument to be selected. If a camera is selected from a list, the method proceeds to step 745.

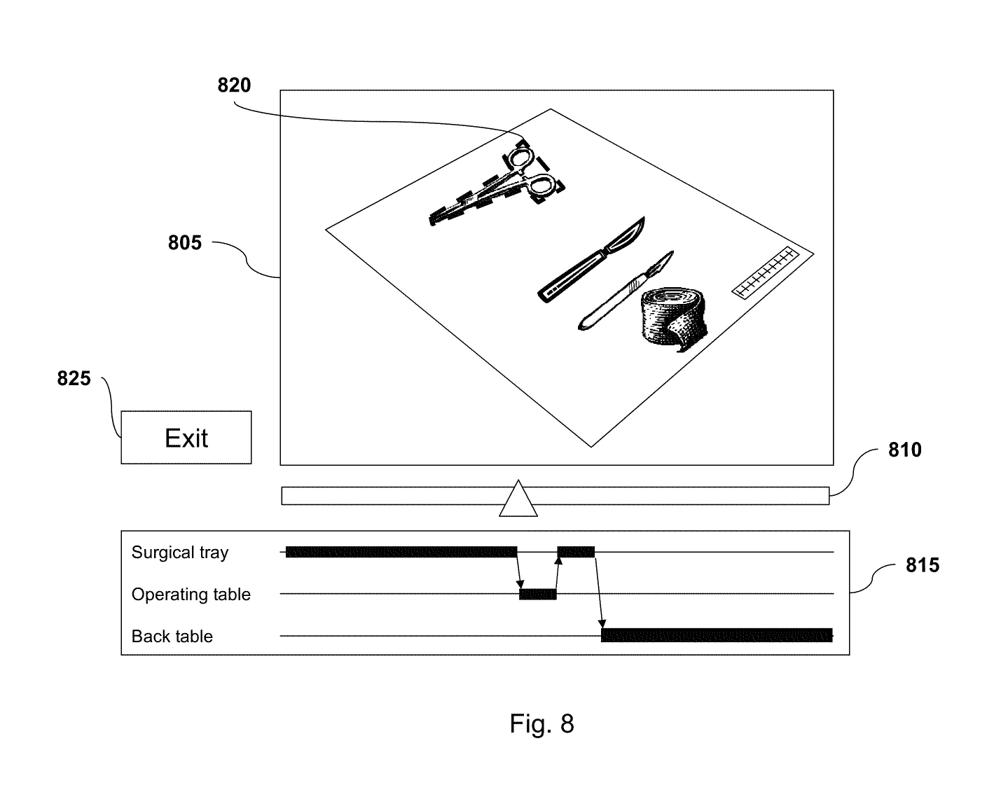

At step 745, the surgical instrument tracker starts playing video from the selected camera and the selected time. FIG. 8 illustrates an exemplary display of the video 805 on, for example, display 260. In some embodiments, the surgical instrument tracker starts playing the video recorded from the selected camera at a time slightly before the time selected, for example, 5 seconds, 10 seconds, or 20 seconds. This allows the medical staff to view the video just before the surgical instrument is moved. In some embodiments, the video from more than one camera may be displayed simultaneously, so that, for example, the surgical instrument can be seen moving from the surgical tray to the operating table.

When the video is being displayed, the medical staff can choose to move to any time within the span of the entire surgery using, for example, slider bar 810 on the display, or any other input method discussed above. In some embodiments, the slide bar may indicate periods of time when the particular instrument was moved, or believed to be at the operating table. In other embodiments, a timeline, for example, timeline 815 for the surgical instrument may be displayed below the slider bar showing the movement of the instrument during the procedure. The surgical instrument tracker may cause the selected instrument to be highlighted 820 in the video to help the medical staff track the instrument.

Returning to FIG. 7, once the video starts playing the method proceeds to step 750. At step 750, the surgical instrument tracker checks to see if the exit button 825 on the display is selected. If the exit button on the display 750 is selected, the method returns to step 740. If the exit button is not selected, the method continues with step 750.

The ability to be able to quickly select a surgical instrument and then play video sequences related to the use and movement of that instrument, is invaluable in tracking misplaced instruments during the procedure. Toward the end of the procedure, if not all the surgical instruments are accounted for the medical staff in the operating room can rapidly look through the parts of the video corresponding to the missing instruments, allowing the location of the surgical instrument either in the patient or on a tray to be determined. When the position is determined, the surgical instrument can be returned to the surgical tray or the back tray to be counted.

In some embodiments, at the end of the procedure, the surgical instrument tracker can be instructed to count the surgical instruments with the supervision of a member of the medical staff. In this process, the surgical instrument tracker recalls the order that instruments were placed on the surgical tray before the surgery began. For each surgical instrument. The surgical instrument tracker highlights on the display the current recorded position of the surgical instrument in the surgical instrument tracker database. The surgical instrument tracker requests that the member of staff confirmed that the recorded identity of the surgical instrument at the highlighted position is correct. In some embodiments, the member of staff is required to remove the surgical instrument from the surgery tray or the back tray and confirm that the identity of the surgical instrument is correct. In these embodiments, the surgical instrument tracker confirms that the member of the medical staff has removed the correct instrument from the surgery tray or the back tray. When all of the surgical instruments originally recorded as having been assembled on the surgery tray before the procedure are accounted for, the surgical instrument tracker indicates that all of the surgical instruments are accounted for. The surgical instrument tracker may indicate that all the surgical instruments are accounted for via the display or by using the synthesized or recorded voice via the speakers.

In some embodiments, the surgical instrument tracker uses images produced by the camera positioned over the operating table to attempt to track and identify instruments on the operating table, in the surgeon's hands or in the patient. This process is more difficult than identifying the surgical instruments on the surgery tray or the back tray, because instruments may be partly obscured, positioned at odd angles, or in a deployed rather than un-deployed state. However, any information regarding the possible position or uses of a surgical instrument on the operating table is useful, even if some is inaccurate, because the information narrows the search times in the video and the positions on the operating table or patient in which to look.

The above tracking and video also allows a misplaced instrument to be found quickly in the middle of a procedure. The surgeon may have used a surgical instrument and returned the surgical instrument to one of the surgery tray or the back tray, but now require the surgical instrument again. The surgical instrument tracker can be queried to locate the position of the surgical instrument and highlight the position on an image on the display.

The above features allow the medical staff in the operating room to be more confident of the positions of instruments in the operating room, and if instruments are misplaces rapidly track and find the surgical instruments. The patient, thus, spends less time on the operating table and is less likely to leave the operating room with a retained instrument. The surgical instrument tracker also makes it more difficult for medical staff to cover up, or be optimistic regarding misplaced instruments, because the surgical instrument tracker is providing a second opinion regarding the location of the surgical instruments. The surgical instrument tracker is also documenting the location of the surgical instruments during the procedure, so that after the procedure if some issue is detected the data collected by the surgical instrument tracker can be used to confirm a diagnosis of a retained instrument. The diagnosis ability may be very useful, for example, to confirm that a suspicious object on an x-ray, CAT scan, or MRI is likely a swab or sponge retained by the patient during surgery.

In some instances, the intent of a procedure is to implant items in a patient. Some implants consist of multiple pieces that are fitted together inside of the patient. The surgical instrument tracker can be used to track the parts for implant as well as the surgical instruments. The surgical instrument tracker has a separate database for images and identities of implantable items. At the beginning of the procedure as the surgical instruments are being assembled, the surgical instrument tracker identifies the implantable parts. The surgical instrument tracker does not allow instruments that it can recognize to be identified as implantable. In some embodiments, the surgical instrument tracker may require, for example, a surgeon to confirm that various parts are implantable before the procedure begins. The surgical instrument tracker may be configured to expect the parts to be implanted in a particular order. Therefore, if an implantable part is removed from the surgery tray before an implantable part that is intended to be implanted first, the surgical instrument tracker may indicate using the synthesized or recorded voice that other part should be implanted first. Such information regarding the implantation order, and the images of the implanted parts may in some embodiments be provided by the manufacturer of the implanted part, on a non-transient computer readable medium such as a hard disk, CD-ROM, DVD, flash memory stick or any other non-transient computer readable medium. In some embodiments, the information regarding the implantation order and images of the implanted parts can be downloaded over a network such as the Internet to the surgical instrument tracker. When all of the implantable parts and no longer on the surgical tray or the back tray, the surgical instrument tracker may indicate using a synthesized the recorded voice that all of the implantable parts are accounted for.

The above embodiments have been described with respect to a surgical tray and a back tray. However, any areas where surgical instruments can be placed and that can be viewed by a camera can be used instead of the surgical tray and the back tray. Moreover, any number of surfaces where surgical instruments can be placed can be included for the surgical instrument tracker to track the positions of surgical instruments. Any one of these surfaces may be designated as a surface where surgical instruments may be placed at the end of the surgical procedure. When all the instruments are found on one of the designated surfaces, the instrument tracker can indicate that all the instruments are accounted for.

Although, the above embodiments have been described with regard to an operating room and surgery instruments, the instrument tracker can also be applied to other situations. For example, a workshop for repairing machinery could use such an instrument tracker to be certain that all of the tools used preparing the machinery are accounted for. Before moving the machinery out of the workshop. Any parts to be replaced in the machinery could be accounted for using the instrument tracker by using similar techniques to account for implanted parts in surgery. In addition, the surgery tracker could be used to track the parts removed from the machinery that have to be reassembled in the machinery before moving the machinery out of the workshop. Thus, for example, parts removed from the machinery can be placed on one of a number of surfaces observed by the cameras. The instrument tracker can be told to track the parts and ensure that none of these parts remain on any of the surfaces at the end of the procedure to repair the machinery. Such an instrument tracking tool would be of great value in workshops dealing with high value, mechanical equipment in which safety and risk management are important, for example, the repair of jet engines or other parts of the an aircraft. The surgical instrument tracker is applicable to any situation where numbers of tools instruments, or parts need to be counted and tracked for any reason.

The embodiments described above are intended to be exemplary. One skilled in the art recognizes that numerous alternative components and embodiments that may be substituted for the particular examples described herein and still fall within the scope of the invention.

What is claimed is:

1. A method of tracking surgical instruments comprising:
imaging predetermined areas with one or more cameras to form time sequences of images;
storing the time sequences of the images in a memory;
recognizing, by a recognition unit, an identity and positions of the instruments or tools in the images of the predetermined areas;
tracking movement of the instruments or tools in and between the predetermined areas using the recognized instruments or tools and the positions of the recognized instruments or tools;
storing a time of the movement of each instrument or tool and storing the identity of the instrument or tool and the time in the memory; and
indicating when a predetermined set of instruments or tools is in predetermined ones of the predetermined areas.

2. The method of claim 1, further comprising determining the predetermined set of instruments based the recognition of instruments or tools in images of the predetermined areas formed before a procedure begins.

3. The method of claim 1, wherein indicating that the predetermined set of instruments or tools is in predetermined one of the predetermined areas comprises outputting using a synthesized or recorded voice.

4. The method of claim 1, wherein each time the movement of a one of the instruments or tools is detected, outputting an indication of the movement using a synthesized or recorded voice indicating the identity of the instrument or tool.

5. The method of claim 1, further comprising displaying a list of the times that a selected instrument was moved based on a request from a user.

6. The method of claim 5, further comprising displaying a portion of the time sequences of the images based on a time selected from the displayed list.

7. The method of claim 1, further comprising determining the predetermined set of instruments or tools based on recognizing, by the recognition unit, the identity and the positions of the instruments or tools in the images of the predetermined areas formed before a procedure is begun.

8. The method of claim 1, wherein the predetermined set of instruments or tools is based on a template of instruments or tools stored in the memory, and the method further comprises determining if all of a list of instruments or tools on the template are recognized by the recognition unit in the images of the predetermined areas formed before a procedure is begun, the template corresponding to the procedure to be performed.

9. The method of claim 1, the method further comprising:
indicating that each of a predetermined set of parts can no longer be recognized by the recognition unit has been in images of predetermined ones of the predetermined areas.

10. The method of claim 1, wherein the instruments or tools are surgical instruments.

11. A system for tracking instruments or tools comprising:
one or more cameras adapted to view predetermined areas;
a memory unit that stores video from the one or more cameras;
a recognition unit adapted to recognize identities and positions of instruments or tools in images produced by the one or more cameras;
a control unit adapted to track positions of the instruments or tools, based on an output of the recognition unit and to store the identities and the positions of the instruments or tools in the memory unit; and
an output unit adapted to indicate to an operator, the positions of the instruments or tools in the predetermined areas, and to indicate when all of a predetermined set of instruments or tools in the predetermined areas are located within a view of one or more predetermined cameras of the one or more cameras.

12. The system of claim 11, wherein the output unit outputs speech indicating that all of the tools in the predetermined areas are located within the view of one or more predetermined cameras of the one or more cameras.

13. The system of claim 12, wherein the control unit is adapted to store in the memory unit times that the positions of the instruments are changed.

14. The system of claim 13, wherein the control unit is adapted to output the times that the position of a selected one of the instruments or tools was changed from the memory unit.

15. The system of claim 14, wherein the control unit is adapted to play portions of the stored video from the one or more cameras corresponding to the times that the position of the selected instrument or tool changed.

16. The system of claim 11, wherein the control unit is adapted to record the identity of each one of the instruments or tools recognized in by the recognition unit in images from the one or more cameras taken before a start of a procedure and to check that each one of the instruments and tools are recognized by the recognition unit in images from the one or more cameras taken at an end of the procedure.

17. The system of claim 16, wherein the control unit is further adapted to record the identity of each one of one or more parts recognized in by the recognition unit in images from the one or more cameras taken before the start of a procedure and to check that each one of each one of the one or more parts not recognized by the recognition unit in images from the one or more cameras taken at the end of the procedure.

18. The system of claim 16, wherein the control unit is further adapted to record the identity of each one of one or more parts recognized in by the recognition unit in images from the one or more cameras taken before the start of a procedure and to check that each one of each one of the one or more parts not recognized by the recognition unit in images from the one or more cameras taken at the end of the procedure.

19. The system of claim 11, wherein the control unit is adapted generate an output to indicate the identity of the instruments moved each time an instrument is moved.

20. The system of claim 11, wherein the instruments or tools are surgical instruments.
